(19) United States
(12) Patent Application Publication
(10) Pub. No.: US 2025/0348298 A1
(43) Pub. Date: Nov. 13, 2025

(54) CROWD-SOURCED DETERMINATION OF TASK DEPENDENCIES

(71) Applicant: SAP SE, Walldorf (DE)

(72) Inventors: Peter Eberlein, Malsch (DE); Volker Driesen, Heidelberg (DE)

(21) Appl. No.: 18/660,782

(22) Filed: May 10, 2024

(51) Int. Cl. G06F 8/61; G06F 9/48

(52) U.S. Cl. CPC G06F 8/61; G06F 9/4881

(57) ABSTRACT

In a computer-implemented method queries, a task executor queries for which tasks of a list of tasks are relevant for a software application installation. The task executor queries for an up-to-date sequence of relevant tasks. The task executor executes the relevant tasks as a completion sequence of tasks used to compute an individual order valuation matrix organized with task identifications in columns and rows. The task executor sends the individual order valuation matrix to a task ordering service. The task executor provides which tasks of a list of tasks are relevant for the software application installation. The task executor receives, from the task ordering service, a newly up-to-date sequence of tasks based on a holistic order valuation matrix.

### BACKGROUND

The described concept is related to manual or semi-automated procedures for information technology (IT) systems, mainly in the context of software applications. The procedures can include many tasks to be performed and the tasks can have dependencies between each other (i.e., a task can only be started when another task is completed).

When a software application is not completely provided as a service, but contains at least some administrator-managed entities (e.g., either deployed on-premises, infrastructure as a service (IaaS), or as a component running in a platform as a service (PaaS)), a larger number of administrators of the software application are required to execute the procedures for individual installations. For different installations, the set of applications, application versions and application configuration being used by users may differ. The list of tasks to be executed is unique to an installation.

When a list of tasks becomes numerous and heterogeneous (i.e., tasks being defined at a software vendor by different people with different roles or responsibilities), it becomes increasingly difficult to define dependencies between the tasks. While some dependencies will likely be correctly defined, in some cases dependencies will be missing.

A list of tasks is published with a certain order that respects known dependencies, but for some tasks, an implementing administrator will realize during execution of the list of tasks that tasks would be better be processed in a different sequence (e.g., either because a later task is actually a prerequisite for an earlier task or because it is logical to reverse an order of task processing for operational reasons). These modifications can cause delays in execution of the list of tasks and additional manual effort for an administrator.

### SUMMARY

The present disclosure describes crowd-sourced determination of task dependencies.

In an implementation, a computer-implemented method, comprising: querying, by a task executor and from a task ordering service, which tasks of a list of tasks are relevant for a software application installation; querying, by the task executor and from the task ordering service, an up-to-date sequence of relevant tasks; executing, by the task executor and as a completion sequence of tasks, the relevant tasks; computing, by the task executor and using the completion sequence of tasks, an individual order valuation (IOV) matrix organized with task identifications in columns and rows; sending, by the task executor and to the task ordering service, the IOV matrix; providing, by the task executor in response to a new query for which tasks of a list of tasks are relevant for the software application installation, which tasks of a list of tasks are relevant for the software application installation; and receiving, by the task executor and from the task ordering service in response to the new query for which tasks of a list of tasks are relevant for the software application installation, a newly up-to-date sequence of tasks based on a holistic order valuation (HOV) matrix.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. Currently, if a list of tasks needs to be executed in a certain order, either task developers define the ordering manually or, if no ordering is provided by the task developer, an administrator identifies ordering and executes tasks in the identified order. However, for a development team to create an ordering of tasks that is verified by tests is a time-consuming activity. Testing can be very costly (e.g., timewise and financially), especially if different situations need to be provided to test different software application setups. On the other hand, for an administrator to identify an ordering based on a description of the tasks and potentially use “try and error” is not very administrator-friendly, effort intensive, and dissatisfying. The described approach utilizes ordering(s) identified by administrators and computes a baseline default ordering to begin with for all future administrators that is based on the feedback by early adopter administrators. Over time, the collective experience results in a more satisfying solution for all administrators. Ordering(s) identified by administrators that process a certain set of tasks can be utilized and improve orderings for future administrators that have a (partially) different set of tasks to process. Such as, if ABC is ordered as ACB, then CBD will be generated rather than BCD based on what the approach learned from the ordering, although different tasks are processed (for example, one administrator only has an A and another administrator only has a D).

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a table illustrating an initial order of task in a task list, according to an implementation of the present disclosure.

FIG. 2 is an example task list illustrating an explicit reordering of tasks in the example task list 100, according to an implementation of the present disclosure.

FIG. 3 is an example task list illustrating marking tasks complete in the reordered example task list 200, according to an implementation of the present disclosure.

FIG. 4 is an example task list illustrating a reordered example task list of FIG. 3 following marking tasks as complete, according to an implementation of the present disclosure.

FIG. 5A is an example task list (or Individual Order Valuation (IOV)) illustrating a completed example task list of FIG. 4 following marking all tasks as complete, according to an implementation of the present disclosure.

FIG. 5B is an example IOV matrix consistent with the example task list of FIG. 5A, according to an implementation of the present disclosure.

FIG. 6A is an example table illustrating combinations of tasks that have been executed by various administrators, according to an implementation of the present disclosure.

FIG. 6B is an example Holistic Order Valuation (HOV) matrix, according to an implementation of the present disclosure.

FIG. 7 illustrates the use of an HOV matrix to determine a new proposed order of tasks, according to an implementation of the present disclosure.

FIG. 8 is a block diagram illustrating components of a computer-implemented system for crowd-sourced determination of task dependencies, according to an implementation of the present disclosure.

FIG. 9 illustrates a method for computing a distance between an IOV and HOV matrix, according to an implementation of the present disclosure.

FIG. 10 is a flowchart illustrating an example of a computer-implemented method for crowd-sourced determination of task dependencies, according to an implementation of the present disclosure.

FIG. 11 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes crowd-sourced determination of task dependencies and is presented to enable any person skilled in the art to make and use the disclosed subject matter in the context of one or more implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

The described concept is related to manual or semi-automated procedures for information technology (IT) systems, mainly in the context of software applications. The procedures can include many tasks to be performed and the tasks can have dependencies between each other (i.e., a task can only be started when another task is completed). A dependency in the sense that a task can only be started after another task is completed, may not only be a technical dependency, but can also be an organizational or operational dependency (i.e., an organization executing the task can have processes defined for execution, which require certain sequences to be followed, although they are not strictly required from a technical perspective). Such dependencies are hard to identify for developers, but for administrators these may be very important- and for administrators with similar uses of a software application and following similar legal requirements, such dependencies or sequences can be very common.

An example task list can include different types of tasks, such as system landscape re-design, data migration/clean-up/archiving, user training, custom code adjustment/transforming modifications to extensions, setting up new graphical user interface (UI) technologies, and delta customizing. In this example, activities in data migration/clean-up, delta customizing, and code adjustment may depend on each other. Other activities may depend on the organization of an administrator and how such tasks are decided and executed.

When a software application is not completely provided as a service, but contains at least some administrator-managed entities (e.g., either deployed on-premises, infrastructure as a service (IaaS), or as a component running in a platform as a service (PaaS)), a larger number of administrators of the software application are required to execute the procedures for individual installations. For different installations, the set of applications, application versions and application configuration being used by users may differ. The task list to be executed is unique to an installation.

When a list of tasks in a task list becomes numerous and heterogeneous (i.e., tasks being defined at a software vendor by different people with different roles or responsibilities), it becomes increasingly difficult to define dependencies between the tasks. While some dependencies will likely be correctly defined, in some cases dependencies will be missing. Typically, dependencies to other tasks working in a similar domain can be specified by developers, but this can be limited to specific area of expertise within a domain and may not cover a complete software application, especially for larger software applications.

A task list is published with a certain order that respects known dependencies, but for some tasks, an implementing administrator will realize during execution of the task list that tasks would be better be processed in a different sequence (e.g., either because a later task is actually a prerequisite for an earlier task or because it is logical to reverse an order of task processing for operational reasons). These modifications can cause delays in execution of the task list and additional manual effort for an administrator.

If a tasks in a task list need to be executed in a certain order, either task developers define the ordering manually or, if no ordering is provided by the task developer, an administrator identifies ordering and executes tasks in the identified order. However, for a development team to create an ordering of tasks that is verified by tests is a time-consuming activity. Testing can be very costly (e.g., both timewise and financially), especially if different situations need to be provided to test different software application setups. On the other hand, for an administrator to identify an ordering based on a description of the tasks using trial and error is not very administrator-friendly, effort intensive, and dissatisfying. The described approach utilizes ordering(s) identified by administrators and computes a baseline default ordering to begins with for all future administrators that is based on the feedback by early adopter administrators (i.e., crowd-sourced feedback). Over time, the collective experience results in a more satisfying solution for all administrators.

At a high-level, the described approach is to extend a GUI of a task management system used by an administrator to organize execution of tasks relevant to their installation and track task completion status by two mechanisms: 1) enabling an administrator to proactively customize task execution order before tasks are started and 2) capturing task completion relative to the completion of other tasks. This information is captured and translated into task sequence information reflecting a sequence in which the tasks were completed for this installation. The information is sent to a provider of the task list.

The provider of the task list captures all feedback on task sequences and computes an optimized sequence based on a superset of all feedback. When a next administrator starts the task list, first a task list management system can identify tasks not relevant for an installation and exclude the identified tasks from the task list. Then the task list management system determines an optimized sequence of tasks (e.g., a sorted list) in the individualized (reduced by non-relevant tasks) task list, based on the feedback of other administrators having executed at least some of the tasks in the task list.

The task list management system sends the sorted list based on the currently available information. When the next administrator then executes the assigned tasks, crowd-sourced feedback on sorting and captured completion order are sent back to the provider, who again updates sequence information with the new crowd-sourced feedback. The update of the sequence information iteratively improves the task list order, and is further optimized with each successive iteration.

The provider of the task list can receive diverse feedback on task list execution. First, the task list being executed can differ between all installations (e.g., non-relevant tasks are either not assigned initially or skipped by the administrator later). A sequence of task completion and information on resorting can be different for each installation, reflecting individual preferences of an administrator or organization the administrator is representing. The task list provider computes a sequence based on a superset of received feedback, identifying commonalities preferred by majority of installations and administrators.

The task list provider can monitor the received sequence information from each installation and the sequence being computed from the feedback. If tasks are reported to be completed in a same sequence by many administrators, the sequencing information is categorized as substantial and generally relevant. If, on the other hand, a reported sequence of two or more tasks varies repeatedly in the received feedback, an alert can be generated for the affected tasks, which do not have a sequence commonly accepted by most administrators.

Tasks associated with alerts can be brought to the attention of task developers, permitting modification of the tasks in a manner where a clear order can be determined. Example reasons for modification can include: 1) the origin for heterogeneous sequencing information (e.g., that tasks are not atomic—a task A is started then B can be started and completed only then A was completed, such as when a task starts with some action items to be completed before an upgrade and finishes with more items after the upgrade, but there are plenty of other tasks in between) or 2) there is an unevaluated parameter in a software application configuration affecting task sequencing. When a task developer is notified about such a situation, a task can be split to make it a set of atomic operations that can be intervened by other tasks, or the task developer can clone the task and specify different relevance conditions making the previously unevaluated parameter explicit. Other solutions consistent with this disclosure as understood by those of ordinary skill in the art are considered to be within the scope of this approach.

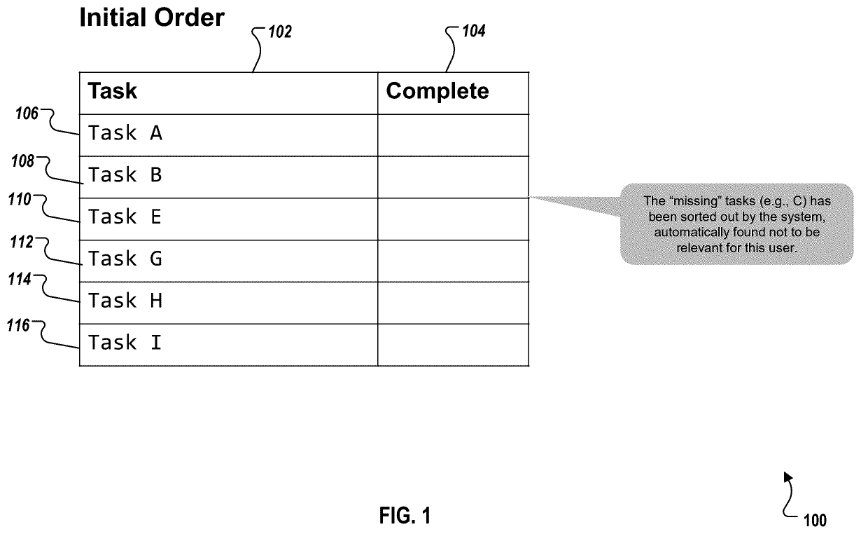

FIG. 1 is an example task list 100 illustrating an initial order of tasks, according to an implementation of the present disclosure. Task list 100 includes a sorted list of tasks 102 and completion fields 104 associated with each task in the list of tasks 102.

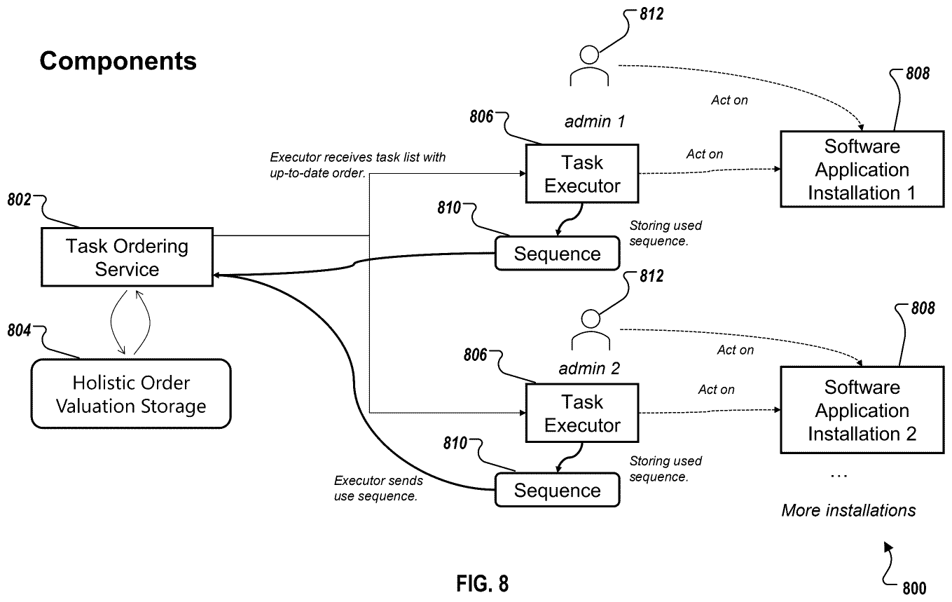

After receiving the example task list 100 (e.g., from a creator of a task list-such as a software application vendor—for a software application installation), an administrator wants to execute the example task list 100. A Task Executor (e.g., refer to FIG. 8) first checks which tasks are relevant to the software application installation. In the example task list 100, Tasks C, D, and F are not present in the list of tasks 102 as they were previously sorted out by the system as not relevant (e.g., “not relevant” or some other designation) for this administrator.

The Task Executor queries a Task Ordering Service of the creator of the task list to receive an up-to-date sequence for the selected (relevant) tasks. In some implementations, the Task Executor has a GUI, where the administrator can execute the automated tasks for which the execution end date and time are captured and used to compute the completion sequence of tasks, which are passed back to the Task Executor. In some implementations, the Task Executor also has a GUI, where the administrator can alter the sequence of tasks to be executed. This allows proactively reordering tasks prior to start of task execution, based on the administrator's knowledge and understanding of a better order for a particular organization, which may be equally applicable to other administrators.

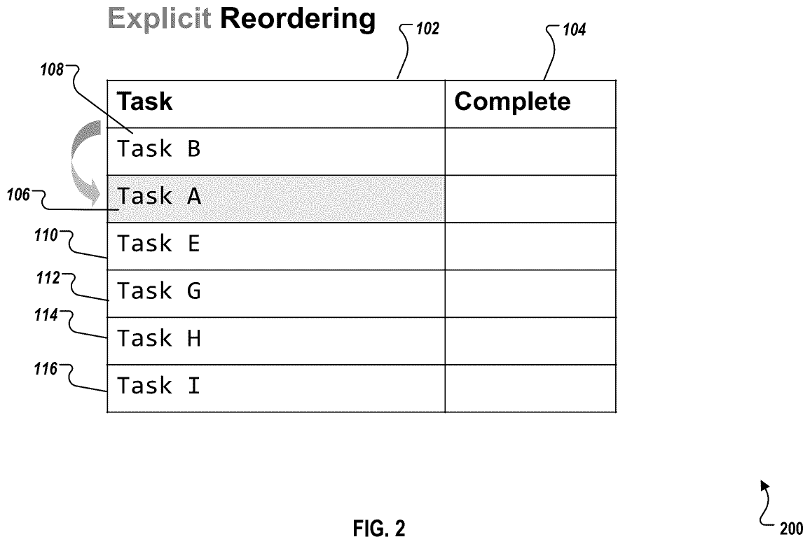

FIG. 2 is an example task list 200 illustrating an explicit reordering of tasks in the example task list 100, according to an implementation of the present disclosure. For example, Task A and Task B, 106 and 108, respectively, have been explicitly swapped (for example, using the GUI associates with the task list 200 or a non-illustrated GUI) by an administrator where Task B is executed prior to task A.

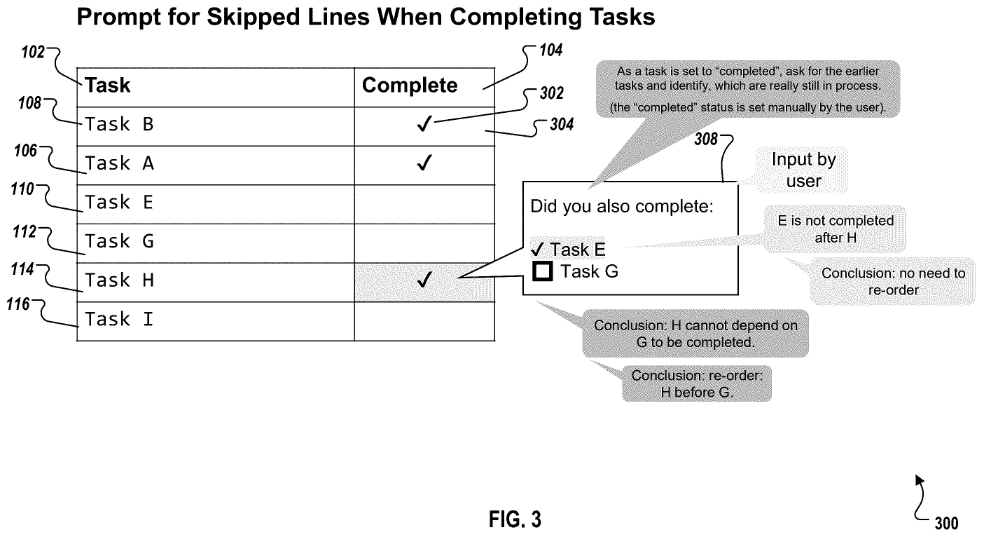

FIG. 3 is an example task list 300 illustrating marking tasks complete in the reordered example task list 200, according to an implementation of the present disclosure. As illustrated in FIG. 3, the GUI associated with the Task Executor permits an administrator to mark a task as completed (e.g., clicking a complete field in task list 300 with a computer mouse to add a check mark (such as, checkmark 302) to the complete field 304 associated with Task B 108). Here, Task B 108, Task A 106, and Task H 114 have been marked as “Completed.”

As the administrator marks each task as complete, the Task Executor checks if all preceding tasks have been marked as completed. For example, when the administrator marked Task A 106 as complete, the Task Executor noted that preceding Task B 108 is also marked completed. However, when the administrator marks Task H 114 as complete, the Task Executor determines that Task E 110 and Task G 112 have not been marked as completed.

In the situation where a task is marked as complete, but preceding tasks are not marked as completed, the Task Executor initiates display of a GUI interface (e.g., a popup/overlay dialog) to query the administrator as to whether the preceding tasks have also been completed. For example, the Task Executor can initiate GUI 308, which contains checkboxes associated with Task E 110 and Task G 112. In some implementations, the administrator can simply select the appropriate checkboxes to indicate whether or not a task is complete. While not illustrated, the GUI 308 could have a close button, “X” button, or the administrator could click outside of the GUI 308 to have it close.

In the provided example of FIG. 3, if there is a preceding task (e.g., Task G 112) which is not completed and the administrator does not mark it as completed, a conclusion is made that the unmarked task (here Task G 112) should be sequentially after the task currently set to completed (here, Task H 114) by the administrator. Similarly, a conclusion can be made that a marked completed task in GUI 308 is completed sequentially before the task currently set to completed (i.e., Task H 114). In the example, Task E 110 marked as completed in GUI 308 should execute sequentially before Task H 114 and there is no need to reorder Task E 110 in the task list 300. However, Task G 112 should be reordered in the task list 300 to execute sequentially after Task H 114, because Task H 114 cannot depend on Task G 112 to be completed.

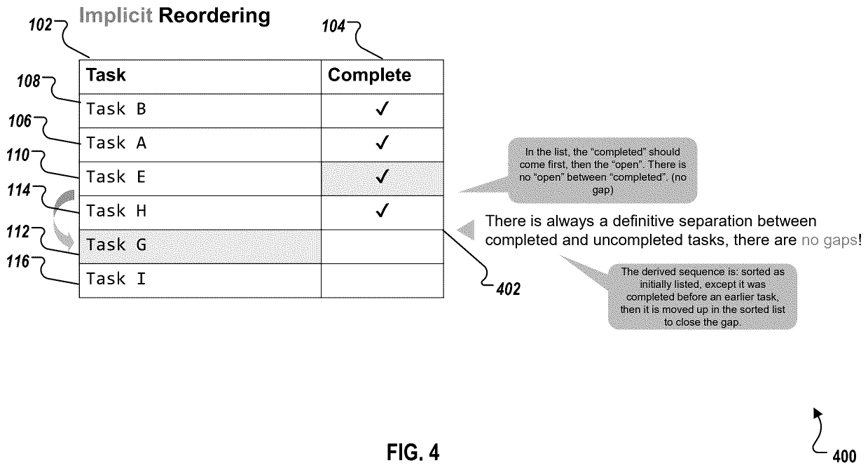

Turning to FIG. 4, FIG. 4 is an example task list 400 illustrating a reordered example task list 300 of FIG. 3 following marking tasks as complete, according to an implementation of the present disclosure. FIG. 4 illustrates implicit ordering of tasks as a result of explicit actions taken by an administrator. For example, based on the discussion related to FIG. 3, Task G 112 and Task H 114 are reordered. Note that a task list should be ordered where marked completed tasks appear in the task list sequentially prior to any non-completed (or “open”) tasks (here, Task G 112 and Task I 116). In other words, there is/will be a definitive separation between completed and uncompleted tasks (i.e., no gaps should be present—as here where Task H 114 is marked as completed but Task G 112 is unmarked).

Once the implicit ordering is complete, the administrator can continue to mark the remaining non-completed tasks (e.g., Task G 112 and Task I 116) if applicable. While not illustrated, in some implementations, a completion status could be set using a GUI to not applicable (e.g., “n/a,” “X,” or some other appropriate designation) to indicate that the task(s) is not applicable to the current, for example, software application installation. Tasks marked as non-applicable are then removed by the Task Executor from further reporting in the order feedback.

At any point in time, looking at the task list 400 and the execution status, tasks are grouped into two sections: 1) first a block of completed tasks and 2) a block of not-yet-completed tasks. As task execution progresses, the first block enlarges and the second block reduces, but at a borderline 402 (e.g., between Task H 114 and Task G 112) there is always a definitive sequential order between the two blocks. Therefore, once the borderline 402 has moved from top to bottom, the final task list represents the task order as it was executed.

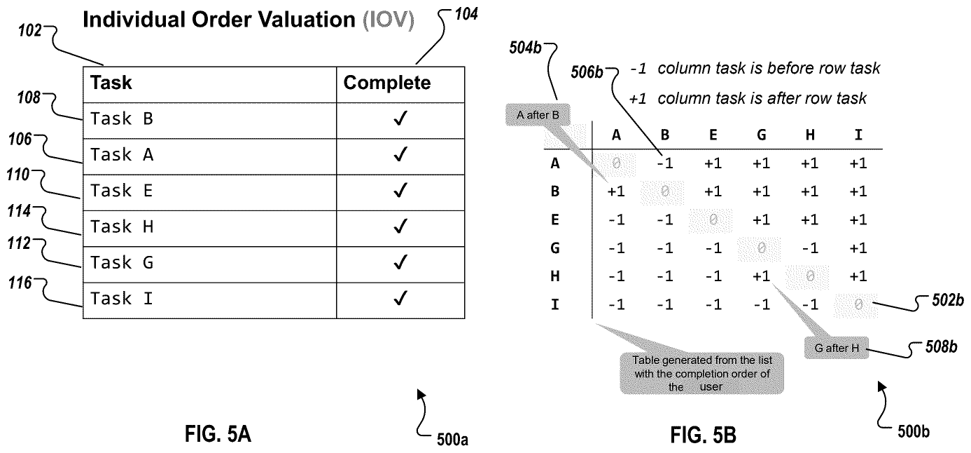

FIG. 5A is an example task list 500a (or Individual Order Valuation (IOV)) illustrating a completed example task list 400 of FIG. 4 following marking all tasks as complete, according to an implementation of the present disclosure. When the set of relevant tasks (not including tasks set to not applicable) are executed and marked as complete, the sequence of tasks is stored. In some implementations, the used sequence of tasks is stored in a database or other data structure.

The sequence of tasks is then translated to an IOV matrix. In some implementations, the IOV matrix is organized with task IDs in rows and columns. An IOV matrix only considers executed tasks, as there is no sequencing information provided for tasks which are determined as not relevant for the installation or set explicitly to not applicable.

Turning to FIG. 5B, FIG. 5B is an example IOV matrix 500b consistent with the example task list 500a of FIG. 5A, according to an implementation of the present disclosure. In the IOV matrix 500b, task IDs are arranged in rows and columns and an ordering-coefficient is defined as an input to compute the values in the matrix, where (note, Tasks C, D, and F are not relevant):
0 is placed on the diagonal 502b (the same task X is specified in row and column).
−1: the task specified in the column is executed before the task specified in the row.
+1: the task specified in the column is executed after the task specified in the row.

As an example, at 504b, the “+1” ordering-coefficient indicates that Task A 104 occurs after Task B 108. Similarly, at 506b, the “−1” ordering-coefficient indicates that Task B occurs before Task A. Similarly, at 508b, the “+1” ordering-coefficient indicates that Task G 112 occurs after Task H 114.

The Task Executor sends the IOV matrix 500b to a Task Ordering Service of the creator of the task list. The Task Ordering Service of the creator of the task list stores the received IOV matrix 500b.

The Task Ordering Service of the creator of the task list then computes a Holistic Order Valuation (HOV) for storage in an HOV Storage (e.g., a database or other data structure), merging the recent feedback received in the IOV matrix 500b with previously received data (e.g., other administrators).

The received recent feedback can be consolidated into individual combinations (or sets) of tasks that have been executed by various administrators. Within a combination, different sequences of tasks may have been received from different administrators.

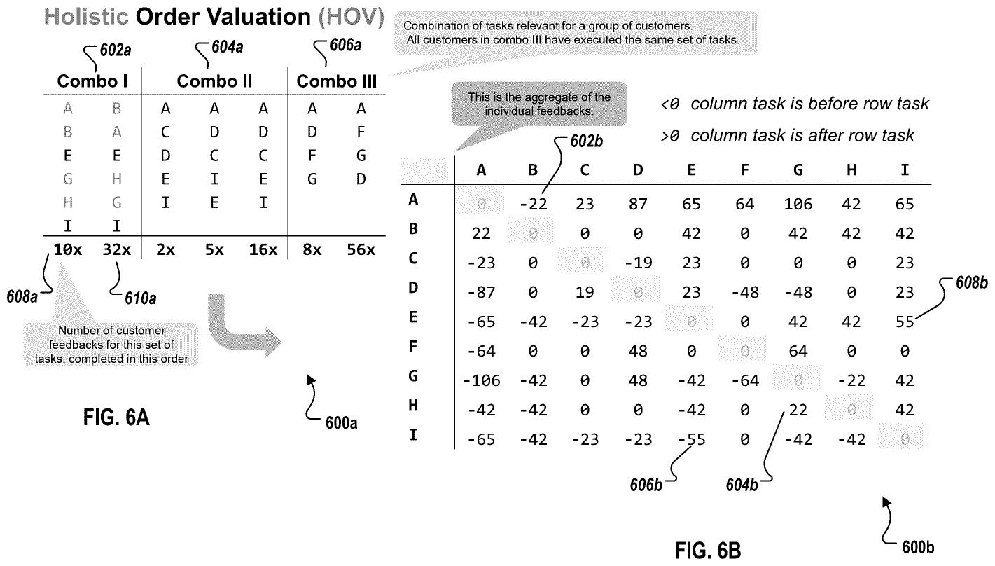

FIG. 6A is an example table 600a illustrating combinations of tasks that have been executed by various administrators, according to an implementation of the present disclosure. For example, table 600a includes three combinations, Combo I 602a, Combo II 604a, and Combo III 606a. Referring to Combo I 602a, two different sequences of the same tasks have been executed by administrators: sequence 1 608a (ABEGHI) and sequence 2 610a (BAEHGI 610a). As an example, note that sequence I 608a was executed/received 10x times and Sequence II 610a was executed/received 32x times.

FIG. 6B is an example HOV matrix 600b, according to an implementation of the present disclosure. As part of the HOV, data from the combinations (e.g., FIG. 6A) is used to generate the example HOV matrix 600b. in the example HOV matrix 600b, task IDs on the rows and columns and values include:
Value 0: no preferred order between the task specified in the column and the task specified in the row (this is also the value on the diagonal that has the same task X specified in row and column).
Value <0: the task specified in the column is sequentially before the task specified in the row.
Value >0: the task specified in the column is sequentially after the task specified in the row.

Continuing the example related to FIG. 6A Combo I 602a, between Sequence 1 608a and Sequence 2 610a, the difference of the number of administrators that preferred Task B before Task A is 22 (i.e., 32−10). Referring to FIG. 6B, 602b reflects that 22 more administrators prefer Task B executed before Task A compared to those that prefer Task A before Task B. Similarly, at 604b, 22 more administrators prefer Task H before Task G. Calculations can be done across combinations. For example, all three Sequences in Combo II 604a execute Task E and Task I. Both Sequences in Combo I 602a execute both Task E and Task I. Referring to FIG. 6B at 606b (or, similarly, 608b), 55 more administrators prefer to execute Task E before Task I (i.e., 5 of 60 prefer to execute Task I before Task E).

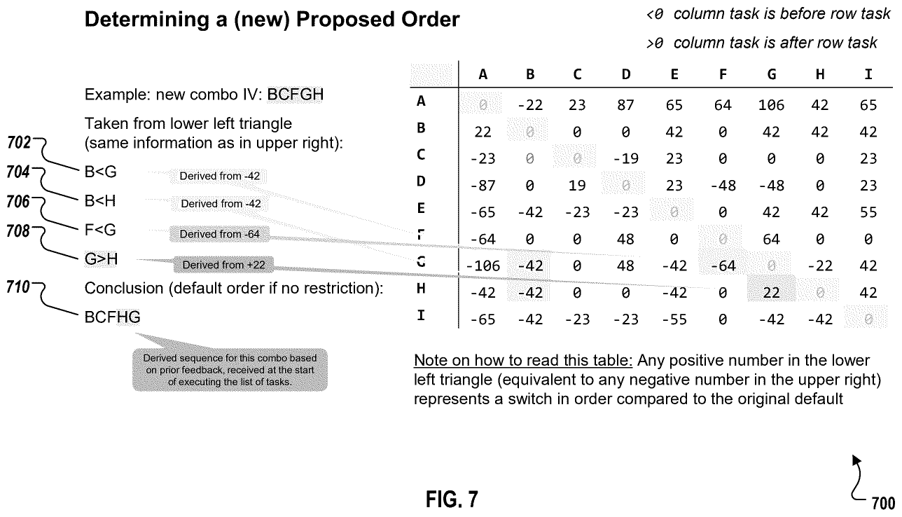

FIG. 7 illustrates the use of an HOV matrix 700 to determine a new proposed order of tasks, according to an implementation of the present disclosure.

When an administrator asks for a proposed task sequence (e.g., a Combo IV) for a software application installation, the Task Executor passes a set of tasks computed as relevant to the software application installation (e.g., Tasks BCFGH). The Task Ordering Service computes a sequence of the tasks for this software application installation by evaluating the HOV matrix 600b associated with FIG. 6B:
At 702, Tasks B and G are analyzed: value is “−42”→thus B is sequentially before G.
At 704, Tasks B and H are analyzed: value is “−42”→thus B is sequentially before H.
At 706, Tasks F and G are analyzed: value is “−64”→thus Fis sequentially before G.
At 708, Tasks G and H are analyzed: value is “+22”→thus G is sequentially after H.

At 710, the sequence returned is BCFHG. The derived sequence for this proposed combination (i.e., Combo IV) is based on prior feedback.

In some implementations, HOV matrix value trend changes over time can be considered (e.g., values increase linearly over time with additional feedback being received—the sequence seems to be OK) or the values change/oscillate over time with additional feedback being received (e.g., administrators provide diverging feedback). In the case when changing/oscillating values in the feedback are observed, and in some implementations, an alert can be provided to the creator of the task list through monitoring the data. For example, a potential reason may be that there is a hidden/unknown parameter and for some administrators (installations), a particular sequence is better. A task could also be non-atomic- and parts of a task are best run before another task and the remaining parts of a task can be run after the other task (so admins give different feedback on their situation). Notifying a task developer on such received feedback allows the developers to investigate the situation and received data in detail and potentially improve the tasks (e.g., split a non-atomic task into two tasks.

Note that in FIG. 6B, some numbers are large (e.g., 106), while some are small (e.g., 22). A changing/oscillating value will be rather small (e.g., less than 10) and observing it at some point being +8 and sometime later with more feedback −7 for example.

For small numbers in the HOV, feedback is heterogeneous. This situation could be brought to the attention of developers to analyze in more detail (and, for example, potentially split a task).

FIG. 8 is a block diagram 800 illustrating components of a computer-implemented system for crowd-sourced determination of task dependencies, according to an implementation of the present disclosure. In some implementations, the components include one or more Administrators 802, a Software Application Installation 802, a Task Ordering Service 802, a Task Executor 804, a Sequence Storage 802, and a Holistic order Valuation Storage 802.

In some implementations, the Task Ordering Service 802 has an application programming interface (API) to query an up-to-date sequence for a given task list (e.g., as described in FIG. 7). The Task Ordering Service 802 is provided with selected tasks relevant for a software application installation and computes a relevant task sequence based on currently stored task sequence information in the previously described HOV matrix. The HOV matrix is stored in an HOV Storage 804. In some implementations, the HOV Storage 804 can be a database or other data structure consistent with this disclosure.

In some implementations, the Task Ordering Service 802 also has an API used by a Task Executor 806 to send a task sequence used for execution in a specific administrator's software application installation (for example, Software Application Installation 1 808). The Task Ordering Service 802 stores the task sequence information together with the information of which tasks had been executed (and thus had been relevant for the software application installation). The Task Ordering Service 802 is also associated with a Sequence 810 module, which can compute the task sequence based on sequence feedback from many Software Application Installations 808.

In some implementations, the Task Executor 806:
Can retrieve a task list to be executed,
Can check, which tasks are relevant for this installation to be executed,
Can call the Task Ordering Service 802 for the up-to-date sequence of the tasks relevant for this installation, and
Has a GUI where administrators (e.g., Administrator 812) can specify a task is to be executed after another task, can configure a task as not relevant, can mark tasks as completed, potentially triggering a prompt asking an administrator about a completion status of other yet uncompleted tasks ordered before a currently processed task,
Can store used and configured sequences of relevant tasks, and can send a sequence of tasks to the Task Ordering Service 802.

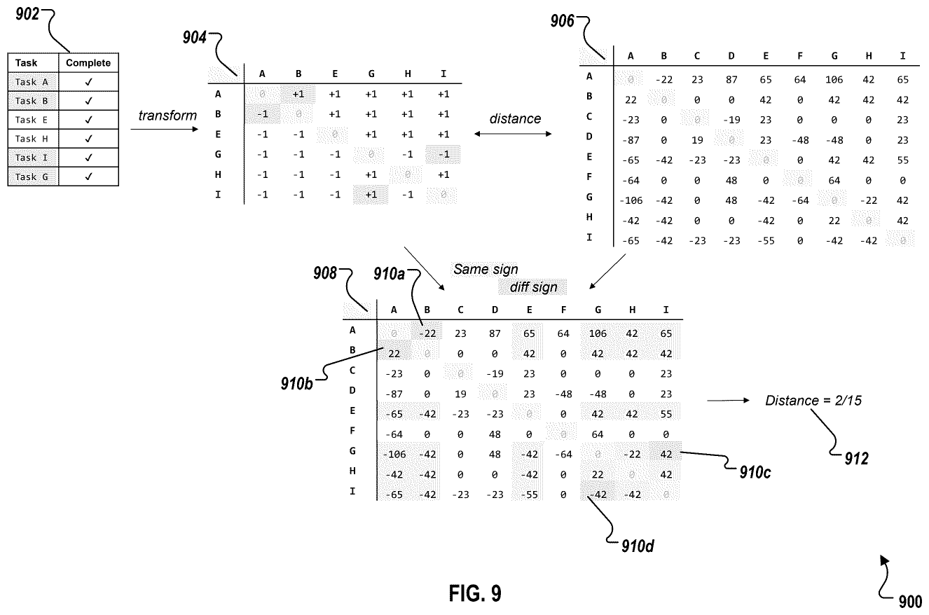

FIG. 9 illustrates a method 900 for computing a distance between an IOV and HOV matrix, according to an implementation of the present disclosure.

A process to compute a HOV matrix can be optimized to reflect IOVs with more weight, that were sent by administrators that usually match a currently derived order of (other) task lists more closely. In this way, feedback by administrator with exceptional configurations (leading to different IOVs) are weighted less and the process converges faster to the desired common result.

In some implementations, to achieve optimization, the ordering-coefficient defined above (the value with which the feedback of an administrator (IOV) is integrated into the HOV matrix) can be weighted based on a “quality” (i.e., closeness) of earlier feedback received by the administrator, so the ordering-coefficient is no longer exactly −1, 0, or +1 but, in some implementations, a float in the range [−1; +1]. For each administrator, a weighting factor is computed. The weighting factor is multiplied with the order-coefficient as determined by the task order to generate a weighted order-coefficient.

The computed weighted order-coefficient is then used to add new feedback of the administrator to the next HOV-matrix. As an example, and in some implementations, the weighting factor can be computed as “one minus an average of distances of all earlier feedback (IOVs) to respective HOVs” sent by an administrator, re-evaluated every time a new IOV is sent.

Referring to FIG. 9, in the example above, task list 902 (IOV) is transformed into IOV matrix 904 and then into HOV matrix 906.

In some implementations, a distance of an IOV (using the IOV matrix) from an HOV matrix can be computed as:
1. For each task in the IOV:
   If the relative order of two tasks matches (they have the same sign), the distance of the tasks is 0.
   If the relative order of two tasks are different (they have a different sign), the distance of the tasks is 1.
2. Sum the distances of the tasks and normalize to get an IOV distance.

The total distance is a number between 0 and 1:

$$distance = \frac{{\sum }_{1 \leq i < j \leq n} match\_order ( {task}_{i} , {task}_{j} )}{{\sum }_{1 \leq i < n} i} .$$

This is repeated for every IOV sent by the administrator, and results in a set of distances. From this, an average distance can be computed. In some implementations, the weighting factor is then one minus the average distance.

For example, the distance between IOV 902 (using IOV Matrix 904) and HOV matrix 906 is 2/15. Note that the distance formula counts different and not different fields in only one half of the HOV matrix (i.e., either below or above the diagonal). As illustrated by distance HOV matrix 908 and between the IOV matrix 904 and HOV matrix 906, two task order signs (910a and 910c) are above the diagonal HOV matrix 908 and two task order signs (910b and 910d) are below the diagonal HOV matrix 908). The two task order signs (either 910a/910c or 910b/910d) above or below the HOV matrix 908 diagonal are different out of the corresponding fifteen applicable task order values (i.e., the other highlighted values) either above or below, respectively, the HOV matrix 908 diagonal. This results in a distance 912→2/15. The weighting factor would then be 1−(2/15).

In some implementations, a machine-learning approach to calculating the weighting factor can include n-dimensional space. For example, a set of tasks for which order information is collected can span an n-dimensional space—with one dimension for each relation between two tasks.

For the IOV matrix 904, with tasks A . . . I, a 36-dimensional space (6×6) can be spanned. For the HOV matrix 906, with tasks A . . . I, an 81-dimension (9×9) can be spanned.

Each IOV can be translated into a vector in the n-dimensional space. For example, for the HOV matrix 906, the first coordinate is +1, if task A is before task B, otherwise it is −1, except if either A or B are not part of the IOV, where the coordinate is 0. The second coordinate is +1, if task A is before task C, otherwise it is −1, except is either A or C are not part of this IOV, in this case the coordinate is 0. This continues for the third, fourth, fifth, sixth, seventh, and eight coordinate.

The ninth coordinate is +1, if task B is before task C, otherwise it is −1, except if either B or C are not part of this IOV, in this case the coordinate is 0. This continues until all coordinates have been determined by comparing the relative position of each task to each other task.

In this way, each IOV is translated into a vector. Two points represented by two vectors with a similar sequence are considered to have a small distance.

Within the n-dimensional space, the HOV can be represented. Alternatively, the centroid of all stored IOVs can be computed. For a new IOV, the distance to the HOV/center can be computed.

In some implementations, the n-dimensional space with all IOV and HOV data points can be fed into machine learning (ML) algorithms (e.g., k-means), where clusters of points can be computed representing task lists with similar sequences. The centroid of the clusters can be computed and the distance of an individual IOV to the centroid of its cluster can be computed—representing a distance to similar sequences.

In this way, provided IOVs can be assessed against the HOV or the centroid of similar submissions. An administrator with IOVs with a small distance to the centroid is granted a higher weighting-factor.

In some implementations, the two approaches can be combined. For example, an algorithmic approach can be used for task lists with low feedback or when collecting feedback is started and there is still a lower data volume. Later, the approach can be switched to the ML approach, once there is enough data.

Ordering evolution can also be analyzed. A Task Ordering Service can be updated upon each administrator executing a task list and sending feedback. Accordingly, a HOV is updated frequently and can be monitored.

In some implementations, an expected behavior is that an order number (i.e, the number in the matrix expressing the strength of order preference for two tasks, like A and G, the value below the diagonal is −106) is increasing (or decreasing) over time. It is expected that administrators to a large percentage will report the same sequence of tasks. If a value increases steadily, a sequence derived from the value is considered stable and seems to be correct for most installations.

In some implementations, expected unusual behavior can include an order number (that is, the number in the matrix expressing the strength of order preference for two tasks, like A and B, the value below the diagonal is 22) is partially increasing and partially decreasing, depending on feedback. It is expected that Administrators report both sequences with similar percentages, preventing the number to grow in absolute numbers. The value is small, changes over time affect the sign (from negative to positive or vice versa), the sequence seems to be “debatable” and not correct for all installations. In this case task developers of the respective tasks can be notified about the heterogeneous or changing feedback regarding the sequence of the two tasks.

When a task developer is notified about such a situation, in some implementations, the task can be split to make it a set of atomic operations or the task can be cloned and execution conditions specified making some unevaluated parameter explicit. For example, if an order of a task A relative to a task B depends on some customized setting X in the installation that is not evaluated when relevant tasks are determined, then the order is not deterministic as administrators with the one setting need to execute task A before task B, whereas other administrators with a different setting X must execute task A after the task B. This can be detected by applied monitoring, and a developer can resolve the situation be cloning task A into A′: The Task Executor can now evaluate customizing switch X and either choose task A or task A′, depending on the value of the switch. As a consequence, one task will be determined to be ordered before B and the other to be after B. This can solve the ambiguity and administrators receive the correct order for their customized situation.

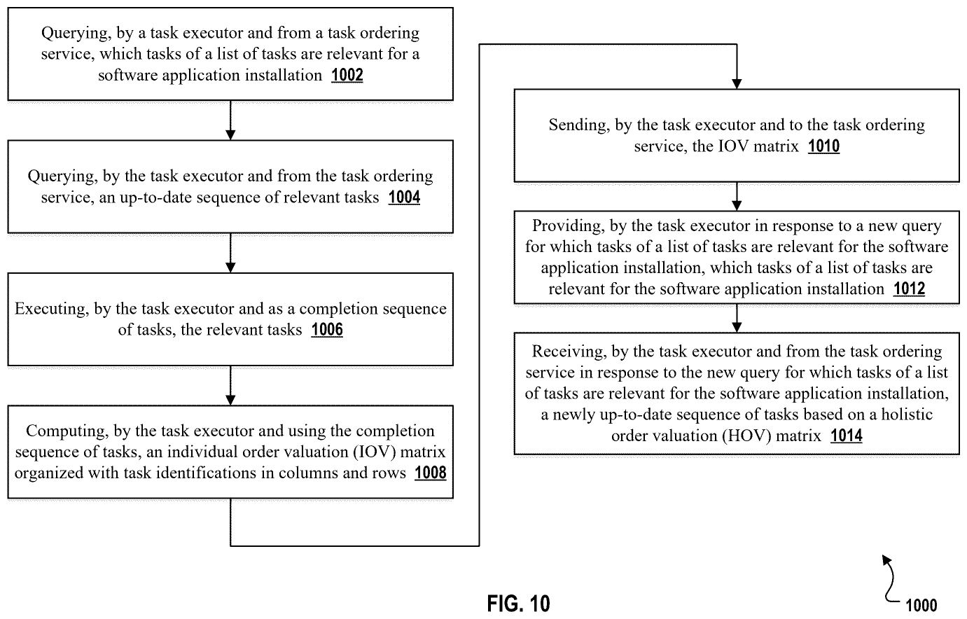

FIG. 10 is a flowchart illustrating an example of a computer-implemented method 1000 for crowd-sourced determination of task dependencies, according to an implementation of the present disclosure. For clarity of presentation, the description that follows generally describes method 1000 in the context of the other figures in this description. However, it will be understood that method 1000 can be performed, for example, by any system, environment, software, and hardware, or a combination of systems, environments, software, and hardware, as appropriate. In some implementations, various steps of method 1000 can be run in parallel, in combination, in loops, or in any order.

At 1002, querying, by a task executor and from a task ordering service, which tasks of a list of tasks are relevant for a software application installation. From 1002, method 1000 proceeds to 1004.

At 1004, querying, by the task executor and from the task ordering service, an up-to-date sequence of relevant tasks. From 1004, method 1000 proceeds to 1006.

At 1006, executing, by the task executor and as a completion sequence of tasks, the relevant tasks. In some implementations, a graphical user interface (GUI) of the task executor permits altering the up-to-date sequence of relevant tasks, marking a task of the up-to-date sequence of relevant tasks as complete, or marking a task of the up-to-date sequence of relevant tasks as not applicable. In some implementations, the up-to-date sequence of relevant tasks is computed using an already stored HOV matrix. In some implementations, the task executor stores the completion sequence of tasks. From 1006, method 1000 proceeds to 1008.

At 1008, computing, by the task executor and using the completion sequence of tasks, an individual order valuation (IOV) matrix organized with task identifications in columns and rows. In some implementations, ordering coefficients are used to compute the IOV matrix, and where the ordering coefficients are: i) 0 indicates a diagonal, ii) −1 indicates a task specified on a column is executed before a task specified in a row, and iii) +1 indicates a task specified on a column is executed after a task specified in a row. In some implementations, the task ordering service uses the IOV matrix and, if applicable, other IOV matrices associated with a same software application installation, to compute the HOV matrix. From 1008, method 1000 proceeds to 1010.

At 1010, sending, by the task executor and to the task ordering service, the IOV matrix. From 1010, method 1000 proceeds to 1012.

At 1012, providing, by the task executor in response to a new query for which tasks of a list of tasks are relevant for the software application installation, which tasks of a list of tasks are relevant for the software application installation. From 1012, method 1000 proceeds to 1014.

At 1014, receiving, by the task executor and from the task ordering service in response to the new query for which tasks of a list of tasks are relevant for the software application installation, a newly up-to-date sequence of tasks based on a holistic order valuation (HOV) matrix. In some implementations, the HOV matrix is organized with task identifications on columns and rows, and where: i) a value of 0 indicates no preferred order between a task specified in a column and a task specified in a row, ii) a value <0 indicates a task specified in a column is sequentially before a task specified in a row, iii) and a value >0 indicates that a task specified in a column is sequentially after a task specified in a row.

In some implementations, the task ordering service computes a distance of a particular IOV matrix from a particular HOV matrix. for each task in the particular IOV matrix and analogous task in the particular HOV matrix: i) if a relative order of two tasks match, a distance between two tasks is 0, and ii) if a relative order of two tasks is different, a distance between two tasks is 1. In some implementations, distances of tasks are summed as a summed value. The summed value is normalized to obtain a total distance to weigh the particular IOV matrix when merged with the particular HOV matrix, where the total distance is provided by:

$$distance = \frac{{\sum }_{1 \leq i < j \leq n} {i}_{} , {task}_{j} )}{{\sum }_{1 \leq i < n} i} .$$

After 1014, method 1000 can stop.

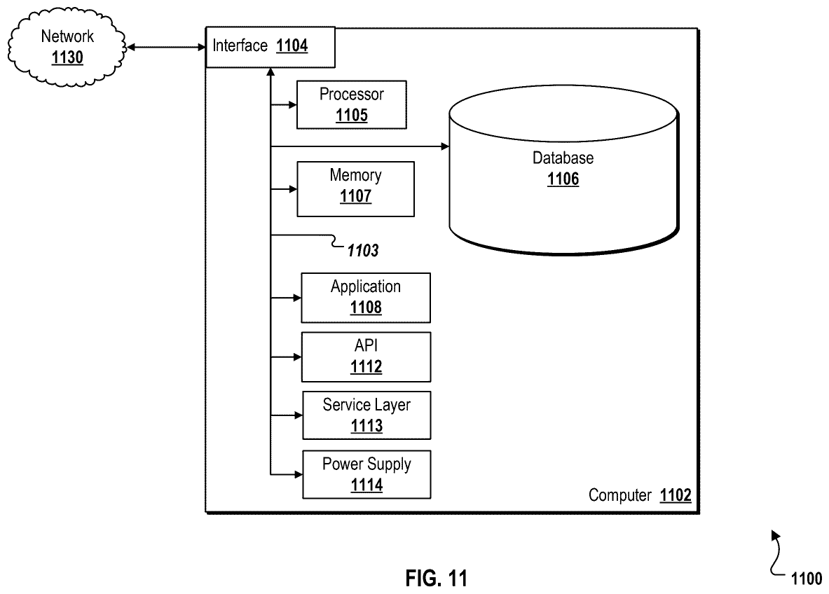

FIG. 11 is a block diagram illustrating an example of a computer-implemented System 1100 used to provide computational functionalities associated with described algorithms, methods, functions, processes, flows, and procedures, according to an implementation of the present disclosure. In the illustrated implementation, computer-implemented system 1100 includes a Computer 1102 and a Network 1130.

The illustrated Computer 1102 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 1102 can include an input device, such as a keypad, keyboard, or touch screen, or a combination of input devices that can accept user information, and an output device that conveys information associated with the operation of the Computer 1102, including digital data, visual, audio, another type of information, or a combination of types of information, on a graphical-type user interface (UI) (or GUI) or other UI.

The Computer 1102 can serve in a role in a distributed computing system as, for example, a client, network component, a server, or a database or another persistency, or a combination of roles for performing the subject matter described in the present disclosure. The illustrated Computer 1102 is communicably coupled with a Network 1130. In some implementations, one or more components of the Computer 1102 can be configured to operate within an environment, or a combination of environments, including cloud-computing, local, or global.

At a high level, the Computer 1102 is an electronic computing device operable to receive, transmit, process, store, or manage data and information associated with the described subject matter. According to some implementations, the Computer 1102 can also include or be communicably coupled with a server, such as an application server, e-mail server, web server, caching server, or streaming data server, or a combination of servers.

The Computer 1102 can receive requests over Network 1130 (for example, from a client software application executing on another Computer 1102) and respond to the received requests by processing the received requests using a software application or a combination of software applications. In addition, requests can also be sent to the Computer 1102 from internal users (for example, from a command console or by another internal access method), external or third-parties, or other entities, individuals, systems, or computers.

Each of the components of the Computer 1102 can communicate using a System Bus 1103. In some implementations, any or all of the components of the Computer 1102, including hardware, software, or a combination of hardware and software, can interface over the System Bus 1103 using an application programming interface (API) 1112, a Service Layer 1113, or a combination of the API 1112 and Service Layer 1113. The API 1112 can include specifications for routines, data structures, and object classes. The API 1112 can be either computer-language independent or dependent and refer to a complete interface, a single function, or even a set of APIs. The Service Layer 1113 provides software services to the Computer 1102 or other components (whether illustrated or not) that are communicably coupled to the Computer 1102. The functionality of the Computer 1102 can be accessible for all service consumers using the Service Layer 1113. Software services, such as those provided by the Service Layer 1113, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 1102, alternative implementations can illustrate the API 1112 or the Service Layer 1113 as stand-alone components in relation to other components of the Computer 1102 or other components (whether illustrated or not) that are communicably coupled to the Computer 1102. Moreover, any or all parts of the API 1112 or the Service Layer 1113 can be implemented as a child or a sub-module of another software module, enterprise application, or hardware module without departing from the scope of the present disclosure.

The Computer 1102 includes an Interface 1104. Although illustrated as a single Interface 1104, two or more Interfaces 1104 can be used according to particular needs, desires, or particular implementations of the Computer 1102. The Interface 1104 is used by the Computer 1102 for communicating with another computing system (whether illustrated or not) that is communicatively linked to the Network 1130 in a distributed environment. Generally, the Interface 1104 is operable to communicate with the Network 1130 and includes logic encoded in software, hardware, or a combination of software and hardware. More specifically, the Interface 1104 can include software supporting one or more communication protocols associated with communications such that the Network 1130 or hardware of Interface 1104 is operable to communicate physical signals within and outside of the illustrated Computer 1102.

The Computer 1102 includes a Processor 1105. Although illustrated as a single Processor 1105, two or more Processors 1105 can be used according to particular needs, desires, or particular implementations of the Computer 1102. Generally, the Processor 1105 executes instructions and manipulates data to perform the operations of the Computer 1102 and any algorithms, methods, functions, processes, flows, and procedures as described in the present disclosure.

The Computer 1102 also includes a Database 1106 that can hold data for the Computer 1102, another component communicatively linked to the Network 1130 (whether illustrated or not), or a combination of the Computer 1102 and another component. For example, Database 1106 can be an in-memory or conventional database storing data consistent with the present disclosure. In some implementations, Database 1106 can be a combination of two or more different database types (for example, a hybrid in-memory and conventional database) according to particular needs, desires, or particular implementations of the Computer 1102 and the described functionality. Although illustrated as a single Database 1106, two or more databases of similar or differing types can be used according to particular needs, desires, or particular implementations of the Computer 1102 and the described functionality. While Database 1106 is illustrated as an integral component of the Computer 1102, in alternative implementations, Database 1106 can be external to the Computer 1102. The Database 1106 can hold and operate on at least any data type mentioned or any data type consistent with this disclosure.

The Computer 1102 also includes a Memory 1107 that can hold data for the Computer 1102, another component or components communicatively linked to the Network 1130 (whether illustrated or not), or a combination of the Computer 1102 and another component. Memory 1107 can store any data consistent with the present disclosure. In some implementations, Memory 1107 can be a combination of two or more different types of memory (for example, a combination of semiconductor and magnetic storage) according to particular needs, desires, or particular implementations of the Computer 1102 and the described functionality. Although illustrated as a single Memory 1107, two or more Memories 1107 or similar or differing types can be used according to particular needs, desires, or particular implementations of the Computer 1102 and the described functionality. While Memory 1107 is illustrated as an integral component of the Computer 1102, in alternative implementations, Memory 1107 can be external to the Computer 1102.

The Application 1108 is an algorithmic software engine providing functionality according to particular needs, desires, or particular implementations of the Computer 1102, particularly with respect to functionality described in the present disclosure. For example, Application 1108 can serve as one or more components, modules, or applications. Further, although illustrated as a single Application 1108, the Application 1108 can be implemented as multiple Applications 1108 on the Computer 1102. In addition, although illustrated as integral to the Computer 1102, in alternative implementations, the Application 1108 can be external to the Computer 1102.

The Computer 1102 can also include a Power Supply 1114. The Power Supply 1114 can include a rechargeable or non-rechargeable battery that can be configured to be either user- or non-user-replaceable. In some implementations, the Power Supply 1114 can include power-conversion or management circuits (including recharging, standby, or another power management functionality). In some implementations, the Power Supply 1114 can include a power plug to allow the Computer 1102 to be plugged into a wall socket or another power source to, for example, power the Computer 1102 or recharge a rechargeable battery.

There can be any number of Computers 1102 associated with, or external to, a computer system containing Computer 1102, each Computer 1102 communicating over Network 1130. Further, the term “client,” “user,” or other appropriate terminology can be used interchangeably, as appropriate, without departing from the scope of the present disclosure. Moreover, the present disclosure contemplates that many users can use one Computer 1102, or that one user can use multiple computers 1102.

Described implementations of the subject matter can include one or more features, alone or in combination.

For example, in a first implementation, a computer-implemented method, comprising: querying, by a task executor and from a task ordering service, which tasks of a list of tasks are relevant for a software application installation; querying, by the task executor and from the task ordering service, an up-to-date sequence of relevant tasks; executing, by the task executor and as a completion sequence of tasks, the relevant tasks; computing, by the task executor and using the completion sequence of tasks, an individual order valuation (IOV) matrix organized with task identifications in columns and rows; sending, by the task executor and to the task ordering service, the IOV matrix; providing, by the task executor in response to a new query for which tasks of a list of tasks are relevant for the software application installation, which tasks of a list of tasks are relevant for the software application installation; and receiving, by the task executor and from the task ordering service in response to the new query for which tasks of a list of tasks are relevant for the software application installation, a newly up-to-date sequence of tasks based on a holistic order valuation (HOV) matrix.

The foregoing and other described implementations can each, optionally, include one or more of the following features:

A first feature, combinable with any of the following features, wherein a graphical user interface (GUI) of the task executor permits altering the up-to-date sequence of relevant tasks, marking a task of the up-to-date sequence of relevant tasks as complete, or marking a task of the up-to-date sequence of relevant tasks as not applicable.

A second feature, combinable with any of the previous or following features, wherein the up-to-date sequence of relevant tasks is computed using an already stored HOV matrix.

A third feature, combinable with any of the previous or following features, comprising: storing, by the task executor, the completion sequence of tasks.

A fourth feature, combinable with any of the previous or following features, wherein ordering coefficients are used to compute the IOV matrix, and wherein the ordering coefficients are: i) O indicates a diagonal, ii) −1 indicates a task specified on a column is executed before a task specified in a row, and iii) +1 indicates a task specified on a column is executed after a task specified in a row.

A fifth feature, combinable with any of the previous or following features, comprising: computing, by the task ordering service using the IOV matrix and, if applicable, other IOV matrices associated with a same software application installation, the HOV matrix.

A sixth feature, combinable with any of the previous or following features, wherein the HOV matrix is organized with task identifications on columns and rows, and wherein: i) a value of 0 indicates no preferred order between a task specified in a column and a task specified in a row, ii) a value <0 indicates a task specified in a column is sequentially before a task specified in a row, iii) and a value >0 indicates that a task specified in a column is sequentially after a task specified in a row.

A seventh feature, combinable with any of the previous or following features, comprising: computing, by the task ordering service, a distance of a particular IOV matrix from a particular HOV matrix; and for each task in the particular IOV matrix and analogous task in the particular HOV matrix: i) if a relative order of two tasks match, a distance between two tasks is 0, and ii) if a relative order of two tasks is different, a distance between two tasks is 1.

An eighth feature, combinable with any of the previous or following features, comprising: summing, as a summed value, distances of tasks; and normalizing the summed value to obtain a total distance to weigh the particular IOV matrix when merged with the particular HOV matrix, wherein the total distance is provided by:

$$distance = \frac{{\sum }_{1 \leq i < j \leq n} {i}_{} , {task}_{j} )}{{\sum }_{1 \leq i < n} i} .$$

In a second implementation, a non-transitory, computer-readable medium storing one or more instructions executable by a computer system to perform one or more operations, comprising: querying, by a task executor and from a task ordering service, which tasks of a list of tasks are relevant for a software application installation; querying, by the task executor and from the task ordering service, an up-to-date sequence of relevant tasks; executing, by the task executor and as a completion sequence of tasks, the relevant tasks; computing, by the task executor and using the completion sequence of tasks, an individual order valuation (IOV) matrix organized with task identifications in columns and rows; sending, by the task executor and to the task ordering service, the IOV matrix; providing, by the task executor in response to a new query for which tasks of a list of tasks are relevant for the software application installation, which tasks of a list of tasks are relevant for the software application installation; and receiving, by the task executor and from the task ordering service in response to the new query for which tasks of a list of tasks are relevant for the software application installation, a newly up-to-date sequence of tasks based on a holistic order valuation (HOV) matrix.

The foregoing and other described implementations can each, optionally, include one or more of the following features:

A first feature, combinable with any of the following features, wherein a graphical user interface (GUI) of the task executor permits altering the up-to-date sequence of relevant tasks, marking a task of the up-to-date sequence of relevant tasks as complete, or marking a task of the up-to-date sequence of relevant tasks as not applicable.

A second feature, combinable with any of the previous or following features, wherein the up-to-date sequence of relevant tasks is computed using an already stored HOV matrix.

A third feature, combinable with any of the previous or following features, comprising: storing, by the task executor, the completion sequence of tasks.

A fourth feature, combinable with any of the previous or following features, wherein ordering coefficients are used to compute the IOV matrix, and wherein the ordering coefficients are: i) 0 indicates a diagonal, ii) −1 indicates a task specified on a column is executed before a task specified in a row, and iii) +1 indicates a task specified on a column is executed after a task specified in a row.

A fifth feature, combinable with any of the previous or following features, comprising: computing, by the task ordering service using the IOV matrix and, if applicable, other IOV matrices associated with a same software application installation, the HOV matrix.

A sixth feature, combinable with any of the previous or following features, wherein the HOV matrix is organized with task identifications on columns and rows, and wherein: i) a value of 0 indicates no preferred order between a task specified in a column and a task specified in a row, ii) a value <0 indicates a task specified in a column is sequentially before a task specified in a row, iii) and a value >0 indicates that a task specified in a column is sequentially after a task specified in a row.

A seventh feature, combinable with any of the previous or following features, comprising: computing, by the task ordering service, a distance of a particular IOV matrix from a particular HOV matrix; and for each task in the particular IOV matrix and analogous task in the particular HOV matrix: i) if a relative order of two tasks match, a distance between two tasks is 0, and ii) if a relative order of two tasks is different, a distance between two tasks is 1.

An eighth feature, combinable with any of the previous or following features, comprising: summing, as a summed value, distances of tasks; and normalizing the summed value to obtain a total distance to weigh the particular IOV matrix when merged with the particular HOV matrix, wherein the total distance is provided by:

$$distance = \frac{{\sum }_{1 \leq i < j \leq n} {i}_{} , {task}_{j} )}{{\sum }_{1 \leq i < n} i} .$$

In a third implementation, a computer-implemented system, comprising: one or more computers; and one or more computer memory devices interoperably coupled with the one or more computers and having tangible, non-transitory, machine-readable media storing one or more instructions that, when executed by the one or more computers, perform one or more operations, comprising: querying, by a task executor and from a task ordering service, which tasks of a list of tasks are relevant for a software application installation; querying, by the task executor and from the task ordering service, an up-to-date sequence of relevant tasks; executing, by the task executor and as a completion sequence of tasks, the relevant tasks; computing, by the task executor and using the completion sequence of tasks, an individual order valuation (IOV) matrix organized with task identifications in columns and rows; sending, by the task executor and to the task ordering service, the IOV matrix; providing, by the task executor in response to a new query for which tasks of a list of tasks are relevant for the software application installation, which tasks of a list of tasks are relevant for the software application installation; and receiving, by the task executor and from the task ordering service in response to the new query for which tasks of a list of tasks are relevant for the software application installation, a newly up-to-date sequence of tasks based on a holistic order valuation (HOV) matrix.

The foregoing and other described implementations can each, optionally, include one or more of the following features:

A first feature, combinable with any of the following features, wherein a graphical user interface (GUI) of the task executor permits altering the up-to-date sequence of relevant tasks, marking a task of the up-to-date sequence of relevant tasks as complete, or marking a task of the up-to-date sequence of relevant tasks as not applicable.

A second feature, combinable with any of the previous or following features, wherein the up-to-date sequence of relevant tasks is computed using an already stored HOV matrix.

A third feature, combinable with any of the previous or following features, comprising: storing, by the task executor, the completion sequence of tasks.

A fourth feature, combinable with any of the previous or following features, wherein ordering coefficients are used to compute the IOV matrix, and wherein the ordering coefficients are: i) 0 indicates a diagonal, ii) −1 indicates a task specified on a column is executed before a task specified in a row, and iii) +1 indicates a task specified on a column is executed after a task specified in a row.

A fifth feature, combinable with any of the previous or following features, comprising: computing, by the task ordering service using the IOV matrix and, if applicable, other IOV matrices associated with a same software application installation, the HOV matrix.

A sixth feature, combinable with any of the previous or following features, wherein the HOV matrix is organized with task identifications on columns and rows, and wherein: i) a value of 0 indicates no preferred order between a task specified in a column and a task specified in a row, ii) a value <0 indicates a task specified in a column is sequentially before a task specified in a row, iii) and a value >0 indicates that a task specified in a column is sequentially after a task specified in a row.

A seventh feature, combinable with any of the previous or following features, comprising: computing, by the task ordering service, a distance of a particular IOV matrix from a particular HOV matrix; and for each task in the particular IOV matrix and analogous task in the particular HOV matrix: i) if a relative order of two tasks match, a distance between two tasks is 0, and ii) if a relative order of two tasks is different, a distance between two tasks is 1.

An eighth feature, combinable with any of the previous or following features, comprising: summing, as a summed value, distances of tasks; and normalizing the summed value to obtain a total distance to weigh the particular IOV matrix when merged with the particular HOV matrix, wherein the total distance is provided by:

$$distance = \frac{{\sum }_{1 \leq i < j \leq n} {i}_{} , {task}_{j} )}{{\sum }_{1 \leq i < n} i} .$$

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/-R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
querying, by a task executor and from a task ordering service, which tasks of a list of tasks are relevant for a software application installation;
querying, by the task executor and from the task ordering service, an up-to-date sequence of relevant tasks;
executing, by the task executor and as a completion sequence of tasks, the relevant tasks;
computing, by the task executor and using the completion sequence of tasks, an individual order valuation (IOV) matrix organized with task identifications in columns and rows;
sending, by the task executor and to the task ordering service, the IOV matrix;
providing, by the task executor in response to a new query for which tasks of a list of tasks are relevant for the software application installation, which tasks of a list of tasks are relevant for the software application installation; and
receiving, by the task executor and from the task ordering service in response to the new query for which tasks of a list of tasks are relevant for the software application installation, a newly up-to-date sequence of tasks based on a holistic order valuation (HOV) matrix.

2. The computer-implemented method of claim 1, wherein a graphical user interface (GUI) of the task executor permits altering the up-to-date sequence of relevant tasks, marking a task of the up-to-date sequence of relevant tasks as complete, or marking a task of the up-to-date sequence of relevant tasks as not applicable.

3. The computer-implemented method of claim 1, wherein the up-to-date sequence of relevant tasks is computed using an already stored HOV matrix.

4. The computer-implemented method of claim 1, comprising:
storing, by the task executor, the completion sequence of tasks.

5. The computer-implemented method of claim 1, wherein ordering coefficients are used to compute the IOV matrix, and wherein the ordering coefficients are: i) 0 indicates a diagonal, ii) −1 indicates a task specified on a column is executed before a task specified in a row, and iii) +1 indicates a task specified on a column is executed after a task specified in a row.

6. The computer-implemented method of claim 1, comprising:
computing, by the task ordering service using the IOV matrix and, if applicable, other IOV matrices associated with a same software application installation, the HOV matrix.

7. The computer-implemented method of claim 6, wherein the HOV matrix is organized with task identifications on columns and rows, and wherein: i) a value of 0 indicates no preferred order between a task specified in a column and a task specified in a row, ii) a value <0 indicates a task specified in a column is sequentially before a task specified in a row, iii) and a value >0 indicates that a task specified in a column is sequentially after a task specified in a row.

8. The computer-implemented method of claim 1, comprising:
computing, by the task ordering service, a distance of a particular IOV matrix from a particular HOV matrix; and
for each task in the particular IOV matrix and analogous task in the particular HOV matrix: i) if a relative order of two tasks match, a distance between two tasks is 0, and ii) if a relative order of two tasks is different, a distance between two tasks is 1.

9. The computer-implemented method of claim 8, comprising:
summing, as a summed value, distances of tasks; and
normalizing the summed value to obtain a total distance to weigh the particular IOV matrix when merged with the particular HOV matrix, wherein the total distance is provided by:
$$distance = \frac{{\sum }_{1 \leq i < j \leq n} {i}_{} , {task}_{j} )}{{\sum }_{1 \leq i < n} i} .$$

10. A non-transitory, computer-readable medium storing one or more instructions executable by a computer system to perform one or more operations, comprising:
querying, by a task executor and from a task ordering service, which tasks of a list of tasks are relevant for a software application installation;
querying, by the task executor and from the task ordering service, an up-to-date sequence of relevant tasks;
executing, by the task executor and as a completion sequence of tasks, the relevant tasks;
computing, by the task executor and using the completion sequence of tasks, an individual order valuation (IOV) matrix organized with task identifications in columns and rows;
sending, by the task executor and to the task ordering service, the IOV matrix;
providing, by the task executor in response to a new query for which tasks of a list of tasks are relevant for the software application installation, which tasks of a list of tasks are relevant for the software application installation; and
receiving, by the task executor and from the task ordering service in response to the new query for which tasks of a list of tasks are relevant for the software application installation, a newly up-to-date sequence of tasks based on a holistic order valuation (HOV) matrix.

11. The non-transitory, computer-readable medium of claim 10, wherein a graphical user interface (GUI) of the task executor permits altering the up-to-date sequence of relevant tasks, marking a task of the up-to-date sequence of relevant tasks as complete, or marking a task of the up-to-date sequence of relevant tasks as not applicable.

12. The non-transitory, computer-readable medium of claim 10, wherein the up-to-date sequence of relevant tasks is computed using an already stored HOV matrix.

13. The non-transitory, computer-readable medium of claim 10, comprising:
storing, by the task executor, the completion sequence of tasks.

14. The non-transitory, computer-readable medium of claim 10, wherein ordering coefficients are used to compute the IOV matrix, and wherein the ordering coefficients are: i) 0 indicates a diagonal, ii) −1 indicates a task specified on a column is executed before a task specified in a row, and iii) +1 indicates a task specified on a column is executed after a task specified in a row.

15. The non-transitory, computer-readable medium of claim 10, comprising:
computing, by the task ordering service using the IOV matrix and, if applicable, other IOV matrices associated with a same software application installation, the HOV matrix.

16. The non-transitory, computer-readable medium of claim 15, wherein the HOV matrix is organized with task identifications on columns and rows, and wherein: i) a value of 0 indicates no preferred order between a task specified in a column and a task specified in a row, ii) a value <0 indicates a task specified in a column is sequentially before a task specified in a row, iii) and a value >0 indicates that a task specified in a column is sequentially after a task specified in a row.

17. The non-transitory, computer-readable medium of claim 10, comprising:
computing, by the task ordering service, a distance of a particular IOV matrix from a particular HOV matrix; and
for each task in the particular IOV matrix and analogous task in the particular HOV matrix: i) if a relative order of two tasks match, a distance between two tasks is 0, and ii) if a relative order of two tasks is different, a distance between two tasks is 1.

18. The non-transitory, computer-readable medium of claim 17, comprising:
summing, as a summed value, distances of tasks; and
normalizing the summed value to obtain a total distance to weigh the particular IOV matrix when merged with the particular HOV matrix, wherein the total distance is provided by:
$$distance = \frac{{\sum }_{1 \leq i < j \leq n} {i}_{} , {task}_{j} )}{{\sum }_{1 \leq i < n} i} .$$

19. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
querying, by a task executor and from a task ordering service, which tasks of a list of tasks are relevant for a software application installation;
querying, by the task executor and from the task ordering service, an up-to-date sequence of relevant tasks;
executing, by the task executor and as a completion sequence of tasks, the relevant tasks;
computing, by the task executor and using the completion sequence of tasks, an individual order valuation (IOV) matrix organized with task identifications in columns and rows;
sending, by the task executor and to the task ordering service, the IOV matrix;
providing, by the task executor in response to a new query for which tasks of a list of tasks are relevant for the software application installation, which tasks of a list of tasks are relevant for the software application installation; and
receiving, by the task executor and from the task ordering service in response to the new query for which tasks of a list of tasks are relevant for the software application installation, a newly up-to-date sequence of tasks based on a holistic order valuation (HOV) matrix.

20. The computer-implemented system of claim 19, comprising:
computing, by the task ordering service, a distance of a particular IOV matrix from a particular HOV matrix;
for each task in the particular IOV matrix and analogous task in the particular HOV matrix: i) if a relative order of two tasks match, a distance between two tasks is 0, and ii) if a relative order of two tasks is different, a distance between two tasks is 1;
summing, as a summed value, distances of tasks; and
normalizing the summed value to obtain a total distance to weigh the particular IOV matrix when merged with the particular HOV matrix, wherein the total distance is provided by:
$$distance = \frac{{\sum }_{1 \leq i < j \leq n} {i}_{} , {task}_{j} )}{{\sum }_{1 \leq i < n} i} .$$
